(19) United States
(12) Patent Application Publication
(10) Pub. No.: US 2006/0191486 A1
(43) Pub. Date: Aug. 31, 2006

(54) Animal feeder for bulky food items

(76) Inventor: Daniel J. Mishler, East Jordan, MI (US)

Correspondence Address: DOUGLAS R. SCHNABEL, 1531 WEDGEWOOD PLACE, ESSEXVILLE, MI, 48732, US

(21) Appl. No.: 11/361,489

(22) Filed: Feb. 25, 2006

Related U.S. Application Data
(60) Provisional application No. 60/655,938, filed on Feb. 25, 2005.

(51) Int. Cl. A01K 1/10

(52) U.S. Cl. 119/51.14

(57) ABSTRACT

An animal feeder that is capable of dispensing bulky feed items at regularly-timed intervals. The feeder of the present invention is useful for attracting wildlife for hunting or recreational photography by placing food on the ground at a regularly scheduled time when there is adequate daylight for viewing. The animal feeder is especially useful for behavioral modification of wildlife species such as the whitetail deer. The feeder dispenses bulk food items from multiple bins using, in one case, a single, moving solenoid release mechanism.

This Patent Application claims priority to the U.S. Provisional Patent Application 60/655,938 filed on Feb. 25, 2005, which is herein incorporated by reference in its entirety.

### FIELD OF THE INVENTION

The invention relates generally to methods and apparatus to dispense bulky food items for animal feeding, and more particularly to methods and apparatus to dispense bulky food items for animal feeding at regularly scheduled times using a multiple bin feeder with a solenoid-based door release mechanism.

### BACKGROUND OF THE INVENTION

Wildlife enthusiasts, such as hunters and photographers, desire to maximize game sighting opportunities. To increase the odds of seeing game, enthusiasts will sometimes lure animals using feeding stations. A feeding station is a location where food is distributed to encourage wild animal visitation. A well-run feeding station can encourage animals to frequent the feeding station on a predictable basis.

If the enthusiast lives near their wildlife feeding station, then the station can simply be restocked, daily, with provisions. However, many enthusiasts live too far away to facilitate a daily visit. Simply placing food at a location once per week, as would be the case, for example, if the enthusiast can only visit a location each weekend, is typically not an effective method for developing a feeding ‘habit’ in the local animal population. For example, if a small amount of food stock is placed on the weekend, it is likely that this food stock may be eaten in a few days. Animals that revisit the site later in the week will fail to find additional food and, as a result, are less likely to become habitual visitors. Conversely, if a large amount of food is placed on the weekend in hopes of providing sufficient food for the whole week, this can also be prove to be counterproductive. For example, many food items will spoil over several days if left on the ground.

A larger problem with leaving a large food pile is the possibility of spreading disease within a group, such as a herd of deer. Diseases can quickly spread between animals that visit a large food pile as visitors pick over the same food pieces. In an effort to limit the spread of diseases that can have an adverse impact on economically important wild game, such as whitetail deer, as well as on domestic livestock, some states have instituted regulations restricting feed stations. In the state of Michigan, for example, no more than two gallons of any type of food item are allowed to be on the ground at a feeding station at any time. Legal restrictions such as this make it even more difficult for the “weekend hunter” to manage a feeding station. It is therefore useful to have a means for automatically dispensing the right amount food at a feeding station each day.

In addition to the desire to dispense the right amount of food each day, it can also be advantageous to dispense food at particular times of the day. Some animals tend to naturally feed after daylight hours. Further, nocturnal feeding may become more pronounced during hunting seasons. However, the enthusiast desires to see animals during the day. To encourage daylight activity, it may be advantageous to distribute food at a feeding station during particular daylight hours. For example, distributing food early in the morning may encourage habitual visitors to frequent the station early in the day before the food pile is eaten by other animals. If this habit can be developed, a wildlife enthusiast can time his or her visits for hunting or photography to advantageously coincide with feeding station cycles. For example, if food is automatically distributed at a feeding station each day at 8 o'clock in the morning, then a hunter might want to arrive at the feeding station area a few hours before 8 o'clock to set-up a hunting blind in hopes of seeing game that has become habituated to the presence of food in the morning. It is therefore useful to have a means to distribute food at particular times during the day.

Automated feeding stations are available on the market for dispensing particular types of food according to a timed schedule. Casting feeders, for example, are useful for dispensing small, dry feed stock, such as grain or shelled corn. However, casting feeders are not useful for dispensing bulky food items, such as sugar beets, apples, carrots, mangos, cabbage, and hay or alfalfa cubes. These bulky food items are often preferred by game enthusiasts for reasons such as cost, aromatic and nutritional properties, and past hunting experiences using particular baits. However, automated feeders capable of handling bulky food items are typically not available to game enthusiasts. It is therefore desirable to have an affordable and portable automated feeder that is well-suited for dispensing bulky food items. The animal feeder of the present invention addresses the problem of dispensing bulk food items in remote locations on a regulated feeding cycle to thereby increase the wildlife sighting opportunities.

### BRIEF DESCRIPTION OF THE DRAWINGS

In the accompanying drawings forming a material part of this description, there is shown:

FIG. 1 illustrates one example of an apparatus for dispensing bulky food items in accordance with one embodiment of the invention based on a radial bin pattern.

FIGS. 2 and 3 illustrate side views of one example of an apparatus for dispensing bulky food items in accordance with one embodiment of the invention.

FIGS. 4 and 5 illustrate side views of one example of an apparatus for dispensing bulky food items in accordance with one embodiment of the invention.

FIG. 6 illustrates an interior view of one example of an apparatus for dispensing bulky food items in accordance with one embodiment of the invention.

FIG. 7 illustrates an interior view of one example of an apparatus for dispensing bulky food items in accordance with one embodiment of the invention.

FIG. 8 illustrates a side-cut view of a top and bottom plate assembly of one example of an apparatus for dispensing bulky food items in accordance with one embodiment of the invention.

FIG. 9 illustrates one example of an apparatus for dispensing bulky food items in accordance with one embodiment of the invention based on another catch type.

FIG. 10 illustrates one example of an apparatus for dispensing bulky food items in accordance with one embodiment of the invention based on a rectangular bin pattern.

FIGS. 11, 12a, and 12b illustrate examples of an apparatus for dispensing bulky food items in accordance with one embodiment of the invention based on a stacked bin pattern.

FIG. 13 illustrates one example of an apparatus for dispensing bulky food items in accordance with one embodiment of the invention based on a vertical bin stack.

### DESCRIPTION OF THE PREFERRED EMBODIMENTS

Briefly, methods and apparatus utilize a solenoid to release trap doors for dispensing bulky food items for animal feeding. Bulky food items are loaded in a plurality of walled bins. Each bin has a trap door and a catch. The catches, when engaged, are operable to support the trap doors. Each trap door is released by energizing a solenoid to forcibly disengage the catch for that trap door and to thereby dispense the bulky food items in that bin. The solenoid is moved between the bins. The solenoid is briefly energized at predetermined times by a timer. The preferred embodiments of the present invention disclose an animal feeder that is capable of dispensing bulky feed items at regularly-timed intervals.

The feeder of the present invention is useful for attracting wildlife for hunting, recreational photography, or the like. The animal feeder is especially useful for behavioral modification of wildlife species such as the whitetail deer. It should be clear to those experienced in the art that the present invention can be applied and extended without deviating from the scope of the present invention.

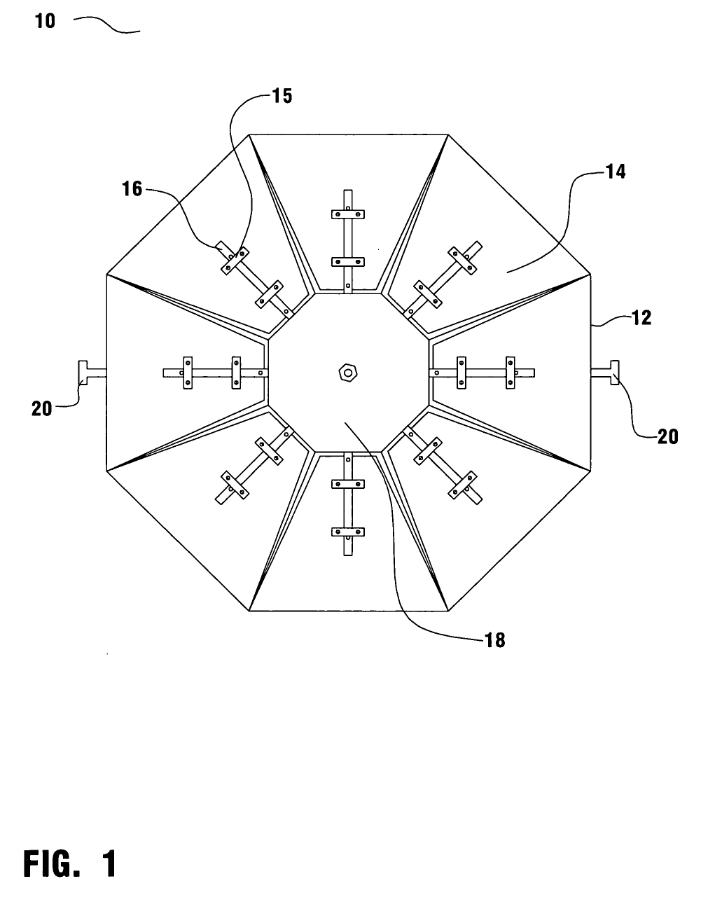

Referring now to FIG. 1, one example of an apparatus for dispensing bulky food items in accordance with one embodiment of the invention is illustrated. This example is based on a radial bin pattern. A bottom view of an animal feeder 10 is shown. The animal feeder of this example comprises a plurality of bins within a radial bin frame 12. A separate trap door 14 is included for each bin. Each trap door 14 may be connected to the bin frame 12 with a hinge (not shown). Each trap door 14 has a catch 16. The catch may be in the form of a catch pin 16 as shown. The catch pins 16 slide in pin guides 15 that are mounted on the trap doors 14. Each catch pin 16 is operable to support a trap door 14 whenever the catch pin is engaged. When engaged, the catch pin 16 rests on a bottom plate 18. During the release process, an individual bin catch pin 16 is triggered, or pushed, or disengaged from the bottom plate 18 such that the trap door 14 is released. As a result, the door 14 opens, and the bulky food items fall through the open door 14. The trap door 14 remains open until the bin is re-loaded by the user. The bin frame 12 has a set of frame mounts 20 on two opposing sides. The bin frame 12 in this embodiment is shown with eight bins. However, it is understood that any number of bins could be constructed within the scope of the present invention.

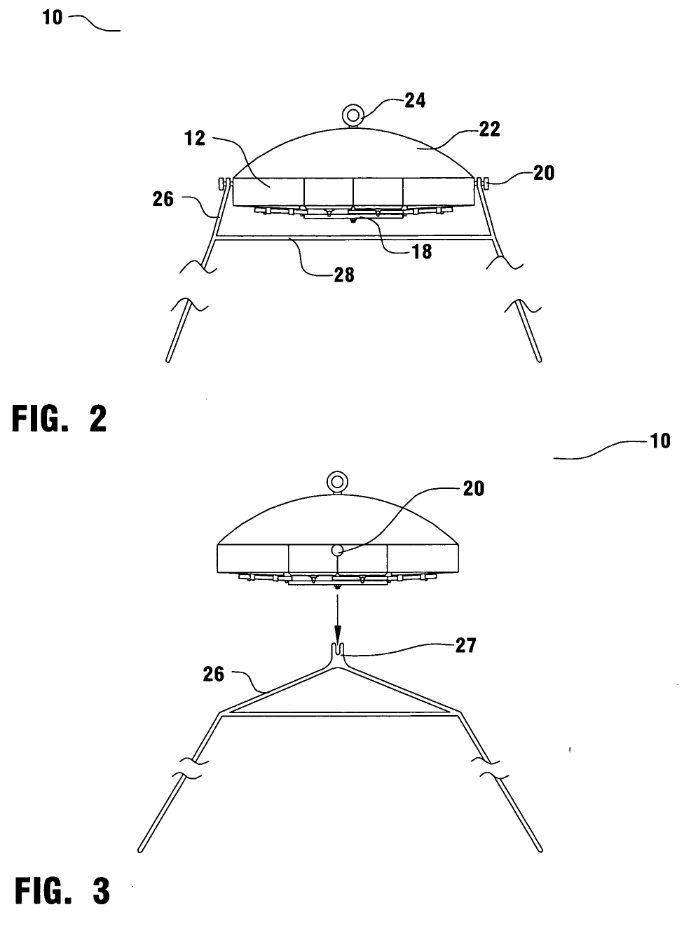

Referring now to FIGS. 2 and 3, the example of an apparatus for dispensing bulky food items in accordance with one embodiment of the invention is further illustrated. The animal feeder is shown in side-view. The animal feeder comprises the bin frame 12, a dome cover 22, optional I-hook 24 and frame mounts 20, a bottom plate 18, a structural frame stand 26, and frame supports 28. The animal feeder 10 may be suspended above a desired feeding area on the structural frame stand 26 to allow ground clearance for animal access. A dome cover 22 may be provided to keep moisture and undesired wildlife away from the food. The structural stand 26 and the frame supports 28 are formed preferably in interlocking sections to allow for ease of transport and assembly in the desired location. FIG. 3 shows the same preferred embodiment from another angle. The structural stand 26 is shown with a receiving section 27 for the frame mount 20.

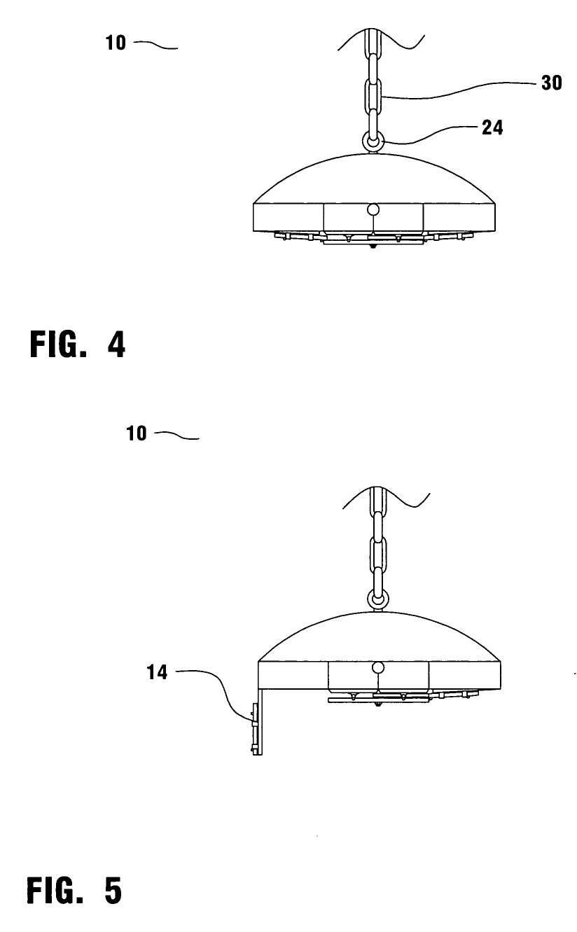

Referring now to FIG. 4, the example of an apparatus for dispensing bulky food items in accordance with one embodiment of the invention is further illustrated. The animal feeder 10 is again shown in side-view. The animal feeder may be suspended from the optional I-hook 24 on a chain 30 above the feeding area. The top-mounted I-hook 24 allows the animal feeder to be suspended from a tree or other structure without the need for the structural frame 26.

Referring now to FIG. 5, the example of an apparatus for dispensing bulky food items in accordance with one embodiment of the invention is further illustrated. The animal feeder 10 is shown with one of the trap doors 14 having been triggered. The animal feeder of the present invention can be visually checked from a distance to see how many feedings are left. This is a valuable advantage over prior art feeders because less human scent is distributed in the desired feeding area.

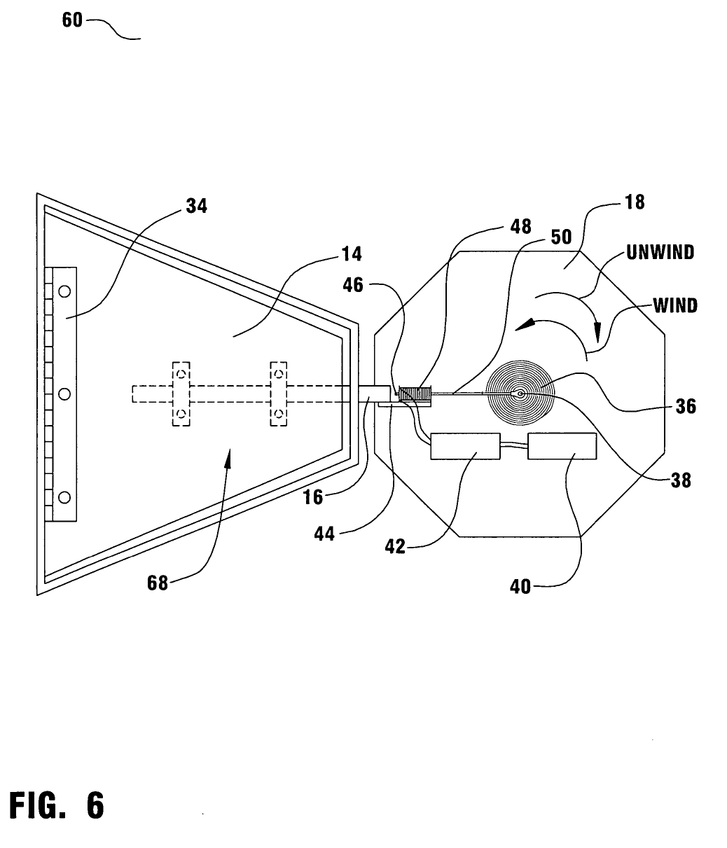

Referring now to FIG. 6, the example of an apparatus for dispensing bulky food items in accordance with one embodiment of the invention is further illustrated. An interior top-view of the electromechanical release mechanism 60 of the feeder 10 is shown. A single trap door 14 of the plurality of doors is shown in this illustration to simplify the schematic. In this example, the electromechanical release mechanism 60 comprises a bottom plate 18, a recoil spring 36, a center rod 38, a solenoid swing arm 50, a solenoid 48, a solenoid push pin 46, a stop block 44, a timer circuit 42, a battery compartment 40, and the catch pin 16.

The solenoid 48 and stop block 44 are fixably attached to the solenoid swing arm 50. The swing arm 50, in turn, is attached to the recoil spring 36. Further, the swing arm 50 slides over the center rod 38 such that the swing arm 50 is capable of rotating 360° around the center rod 38. The recoil spring 36 is further attached to the bottom plate 18 such that a rotational spring force can be applied to the solenoid swing arm 50 by winding. This spring force is converted into rotational movement in the direction opposite of the winding and is used to move the solenoid from bin to bin. Alternatively, the rotational force may be supplied by a weight, motor, or other device attached to the swing arm. The stop block 44 is aligned to engage the side of each catch pin 16 of each trap door 14 of the feeder. As a result, the rotation of the swing arm 50 is stopped when the stop block 44 encounters the next loaded catch pin 16. The solenoid is oriented such that the solenoid push pin 46 is aligned to the same plane as the catch pin 16. When the solenoid 48 is briefly energized, the push pin 46 is pushed by electromechanical force. The catch pin 16 is thereby disengaged from the bottom plate 18 to no longer support the trap door 14. As a result, the trap door 14 swings open about its hinge 34.

Prior to loading with bulky food items, the operator winds the solenoid swing arm 50 in order to tension the recoil spring 36. The trap doors 14 are closed, and the catch pins 16 are engaged to overlap the bottom catch plate 18. The bin areas 68 may then be loaded with the desired food items. The recoil spring 36 forces the solenoid stop block 44 to rest against the nearest catch pin 16. The solenoid 48 will stay in this position until the solenoid 48 is briefly energized by the timer circuit 42. When the solenoid 48 is energized, the solenoid push pin 46 disengages catch pin 16 by pushing it toward the trap door hinge 34. The catch pin 16 slides in the pin guides until the pin 16 disengages with the bottom catch plate 18. The trap door 14 then opens and releases the food items from the bin area 68. A timer circuit 42 is preferably used to control the timing of the solenoid energization. The timer circuit 42 is preferably powered by a battery 40 to allow for operation in a remote area. After the solenoid 48 is triggered and the trap door 14 is opened, the recoil spring 36 forces the advancement of the solenoid stop block 44 to the location of the next available trap door 14 and catch pin 16. The electromechanical mechanism 60 then waits for the next scheduled feeding event from the timer circuit 42. The combination of the spring-driven (or weight-driven or motor-driven) movement of the solenoid 48 from bin to bin and the stoppage of the solenoid at each bin via a stopping block, allows the feeder apparatus to utilize a single solenoid as the unlatching mechanism for multiple bins. A cost effective feeder capable of dispensing bulky food items is thereby achieved.

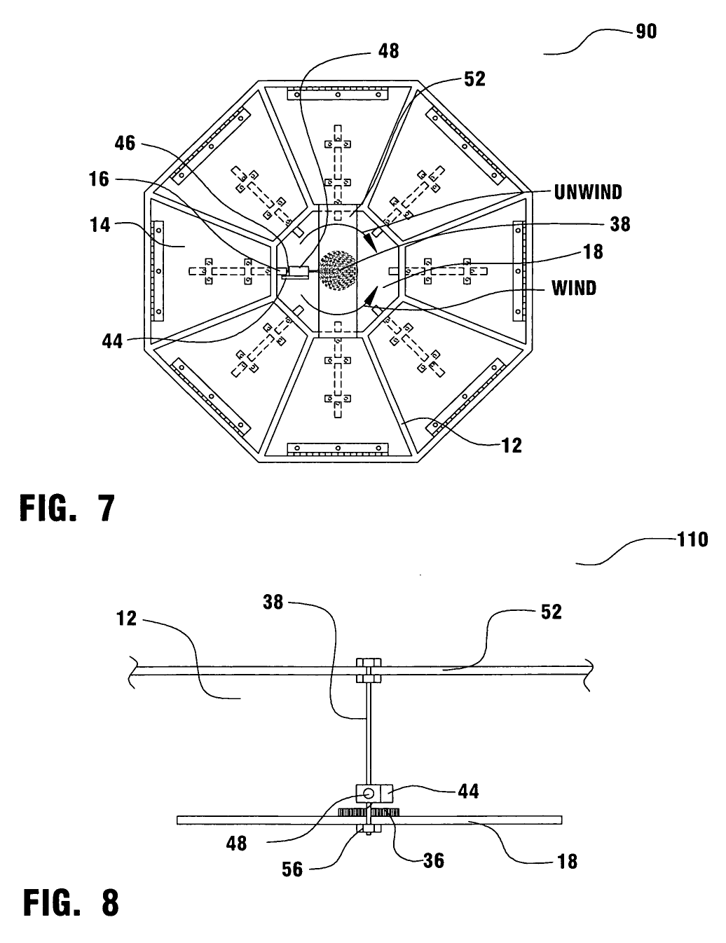

Referring now to FIG. 7, the example of an apparatus for dispensing bulky food items in accordance with one embodiment of the invention is further illustrated. In this example, the bins are arranged in a radial pattern around the center rod 38. The solenoid 48 is wound in one direction and unwound in the other direction. As the solenoid 48 unwinds, it moves from bin to bin stopping at each engaged catch pin 16. A further view of the top plate 52 and electromechanical release mechanism 90 is shown in FIG. 8. The center rod 54 is shown in this embodiment with a locking nut 56 to support the bottom plate 18.

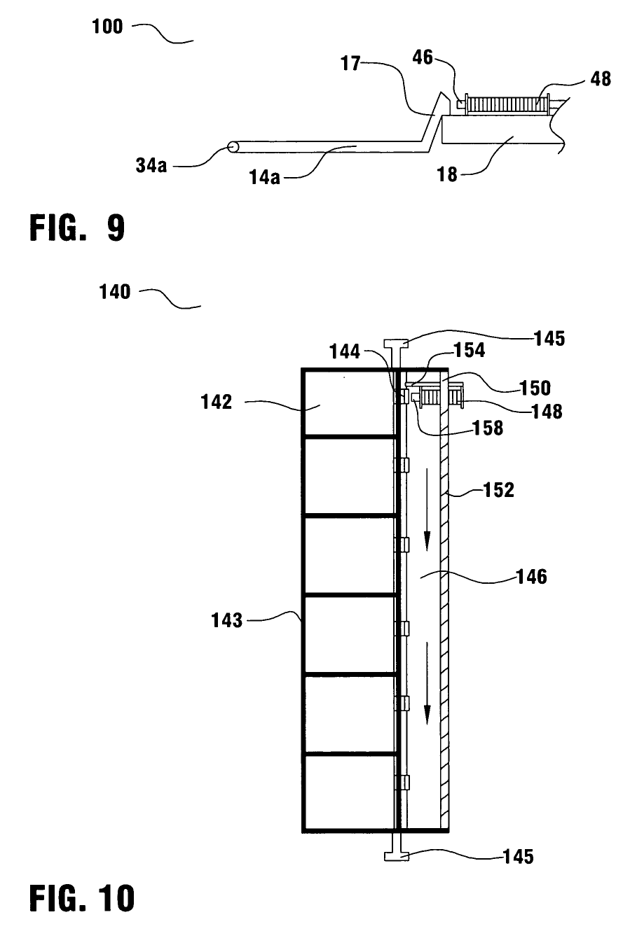

Referring now to FIG. 9, another example of an apparatus for dispensing bulky food items in accordance with one embodiment of the invention is illustrated. In this case, a different type of catch 17 is shown. This catch 17 hooks over the edge of the bottom catch plate 18 when engaged and is disengaged by flexing or pivoting the catch 17 such that the catch 17 slides past the edge of the plate 18. The catch may be integrated into the trap door 14a by, for example, forming the trap door 14a and catch 17 of the same material. The catch 17 and trap door 14a may be formed, for example, of a semi-flexible, resin-based material. A semi-flexible, resin-based material allows the catch 17 to hinge on the trap door 14a and spring into the latched position upon closing. The integrated catch 17 and trap door 14a rest on the bottom plate 18 until a feeding event is called for by the timer circuit 42. When the timer circuit 42 triggers the solenoid 48, it extends a solenoid push pin 46 with enough force to disengage the integrated catch 17 off of the bottom plate 18. When the integrated catch 17 is forced off of the bottom plate 18, the trap door 14a swings on the hinge 34a and allows the food items to fall to the ground.

Referring now to FIG. 10, another example of an apparatus for dispensing bulky food items in accordance with one embodiment of the invention is illustrated. A top-view of an animal feeder 140 is shown. In this example, the animal feeder 140 comprises a plurality of bins 142 that are aligned in a rectangular pattern, or array. A separate trap door is included for each bin. Each trap door is connected to the bin frame 143 with a hinge and has a catch pin 144 that rests on a bottom plate 146 when in the loaded position. The bin frame 143 has a set of frame mounts 145 on the two opposing ends. The cover for the animal feeder 140 in this embodiment is not shown. However, it is designed such that the electromechanical release mechanism and the bins are sealed to protect the feeder and the enclosed bait from the elements and other non-desired wildlife intrusions. The bin frame 143 in this embodiment is shown with six bins. However, it is understood that any number of bins could be constructed within the scope of the present invention.

During the release process, an individual bin catch pin 144 is triggered, or pushed, off of the bottom plate 146 and the trap door is opened to release the bulk food item. The trap door remains open until the bin is re-loaded by the user. The solenoid 148 and stop block 154 slide along a guide rod 150. The guide rod 150, in turn, is attached to a horizontal spring 152. Further, the solenoid 148 is capable of traveling the extent of the guide rod 150. Therefore, the solenoid 148 is operable to move from bin to bin along a linear path as opposed to around an arc as in the prior example. The horizontal spring 152 is further attached to the bin frame 143 such that a spring force can be applied to the solenoid 148 and the solenoid travel path directed by the guide rod 150. Alternatively, the horizontal force may be supplied by a weight or motor operatively coupled to the solenoid. A stop block 154 is aligned to engage the side of each catch pin 144 such that the travel of the solenoid 148 is stopped by the catch pin 144. Finally, the solenoid 158 is aligned to the same plane as the catch pin 144. When the solenoid 148 is electrically activated, it will force the catch pin 144 to slide away from the catch plate to allow the trap door to fall.

Prior to loading with bait, the operator tensions the horizontal spring 152 by forcing the solenoid 148 to one end of the bin frame. The trap doors are closed, and the bin areas are loaded with the desired food items. The trap doors are supported by hinges and by the catch pins 144, which rest on the bottom plate 146. The horizontal spring 152 forces the stop block 154 to rest against the nearest catch pin 144. When the solenoid 148 is briefly energized by the timer circuit, the solenoid push pin 158 pushes the catch pin 144 away from the bottom catch plate 146. As a result, the food items are dispensed from that bin. After the trap door is opened, the horizontal spring 152 forces the advancement of the solenoid 148 to the location of the next available trap door and catch pin 144. The solenoid stop block 154 halts and holds the solenoid 148 at the next engaged catch pin 144. The animal feeder 140 then waits for the next scheduled feeding event from the timer circuit.

In another embodiment, the animal feeder 140 may include a second array of bins, not shown, opposite the first, with the solenoid 148 and guide rod 150 in between. In this embodiment, the stop block may be lengthened to allow for alignment with the second set of pin catches. The solenoid, in this embodiment, is a bi-directional solenoid, having the ability to push in the direction of the first bin on one feeding and in the direction of the second bin on the next feeding. After the first bin door is released the stop block remains engaged with the opposing side's catch pin so the solenoid does not advance until after the second trap door is released. When the second trap door is released, the horizontal spring forces the solenoid to the next set of trap doors to wait for the next scheduled feeding.

In yet another embodiment, the animal feeder 140 may include a second array of bins, not shown, opposite the first, with the solenoid 148 and guide rod 150 in between. In this embodiment, the catch pins on one side are lengthened and designed with a reverse-hook latch to allow them to rest on the bottom plate next to the catch pins from the first side. The solenoid, in this embodiment, is a one-directional solenoid that releases the first bin on one feeding. After the first bin door is released the stop block advances to the opposing side's catch pin and waits until the next scheduled feeding event. When the second trap door is released, the horizontal spring forces the solenoid to the next set of trap doors to wait for the next scheduled feeding.

As stated previously, it is desirable to increase the chance of the hunter or recreational viewer seeing more wildlife. The animal feeder of the present invention helps to increase the odds by placing food on the ground at a regularly scheduled time when there is adequate daylight for viewing. The animal feeder of the present invention provides for an extended, daily pattern of feeding, that helps to reduce the amount of human scent in the area. Further embodiments of the present invention may help to further extend the amount of time between fillings.

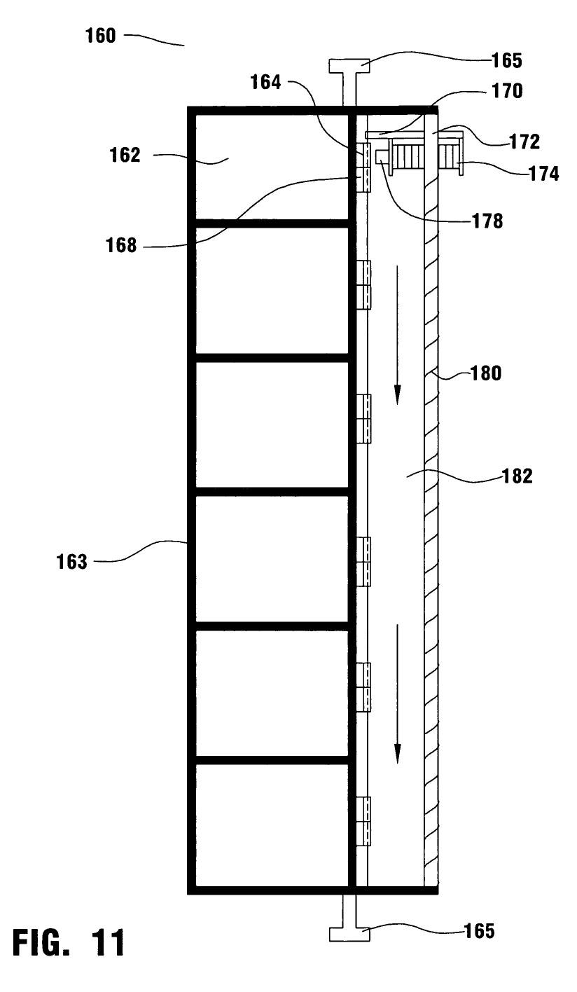

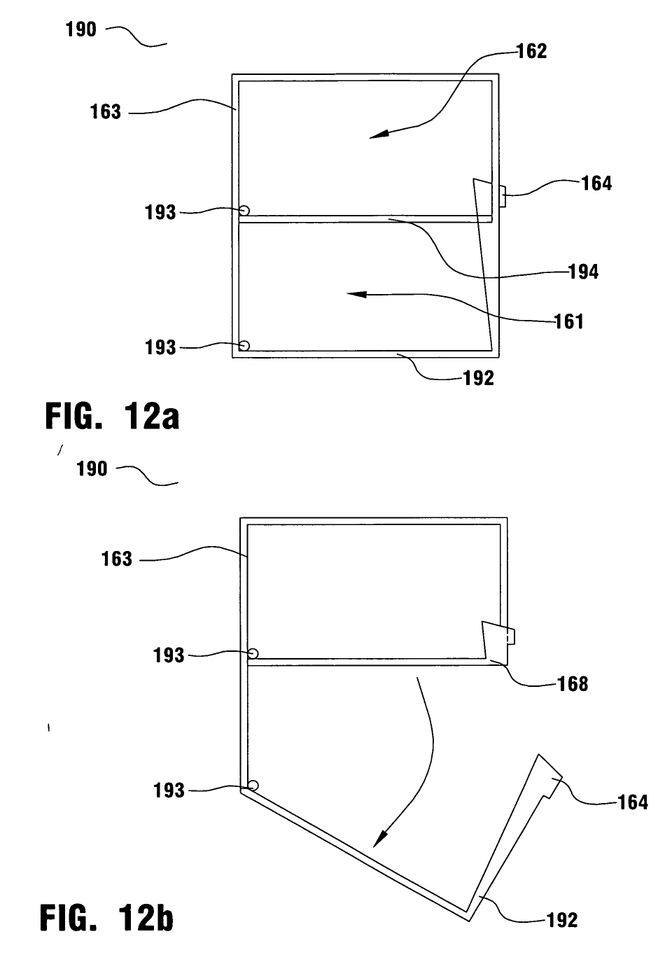

Referring now to FIGS. 11, 12a, and 12b, another example of an apparatus for dispensing bulky food items in accordance with one embodiment of the invention is illustrated. A top-view of an animal feeder 160 is shown. In this example the animal feeder 160 includes a plurality of upper bins 162 that are vertically stacked on top of another plurality of lower bins 161. A separate trap door 194 and 192 is included for each upper and lower bin, respectively. Each lower bin trap door 192 is connected to the bin frame 163 with a hinge 193 and has a catch 164. In one embodiment, the catches are planar to the lower trap door as in the first embodiment of the present invention. In this case, each catch rests on a bottom plate 182 when in the loaded position. Each upper bin trap door 194 is connected to the bin frame 163 with a hinge 193 and has a catch planar to the trap door 194 that rests on a bottom plate 182 when in the loaded position. The bin frame 163 has a set of frame mounts 165 on the two opposing ends. The cover for the animal feeder 160 in this embodiment is not shown. However, it is designed such that the electromechanical release mechanism and the bins are sealed to protect the feeder, and the enclosed bait from the elements and other non-desired wildlife intrusions. The bin frame 163 in this embodiment is shown with six upper and lower bins. However, it is understood that any number of bins could be constructed within the scope of the present invention.

The upper and lower bin assembly 190 is illustrated in a side-view in FIGS. 12a and 12b. In the illustration, another example having a flexing or pivoting catch 164 is shown. The bin assembly 190 comprises the bin frame 13, hinges 193, upper trap door 194, lower trap door 192, upper catch 168, and the lower catch 164. The lower trap door 192 is attached to the bin frame 163 and a lower catch 164 with a hinge 193. The lower catch 164 may be integrated into the lower trap door such that the lower catch 164 is offset from the upper catch 168. The offset would allow for the lower catch 164 to rest on the bottom plate next to the upper catch 168. The catches 164 and 168 rest on the bottom plate until a triggered feeding event. The upper trap door 194 has a catch 168 and is attached to the bin frame 163 with a hinge 193. The upper trap door 194 is designed with enough clearance to allow the lower catch 164 access to the bottom plate. The upper catch 168 rests on the bottom plate next to the lower catch 164 until a triggered feeding event.

As in the prior example, in the vertical arrangement the solenoid 174 and stop block 170 slide on a guide rod 172. The guide rod 172, in turn, is attached to a horizontal spring 180. Further, the solenoid 174 slides along the guide rod 172 such that the solenoid 174 is capable of traveling the extent of the guide rod 172. The horizontal spring 180 is further attached to the bin frame 163 such that a horizontal spring force can be applied to the solenoid 174. The stop block 170 is aligned to engage the side of each lower and upper catches 164 and 168 such that the travel of the solenoid 174 is stopped by the catches 164 and 168. Finally, the solenoid push pin 178 is aligned to the same plane as the catches 164 and 168. When the solenoid 174 is energized, the solenoid push pin 178 is electromechanically driven into the lower or upper catches 164 and 168 with sufficient energy to force the lower or upper catches 164 or 168 off of the bottom plate 182.

Prior to loading with food items, the operator extends the solenoid 174 in order to tension the horizontal spring 180. The upper and lower bin areas are loaded with the desired food items, and the trap doors are closed. The trap doors 192 and 194 are supported by the hinges 193 and the catches 164 and 168, which rest on the bottom plate 182. The horizontal spring 180 forces the stop block 170 to rest against the lower or upper catch pin 164 or 168 until the solenoid 174 is triggered by the timer circuit (not shown) that is powered by the battery compartment (not shown). When the solenoid push pin 178 is engaged by the solenoid 174 it pushes to the left and into the lower or upper catches 164 and 168. The force of the solenoid push pin 178 pushes the lower or upper catches 164 and 168 off of the bottom plate 182 such that the trap door opens and releases the bait from the bin area.

After the solenoid 174 is triggered and the trap door is opened, the horizontal spring 180 forces the advancement of the solenoid stop block 172 to the location of the next available upper or lower catch pin 164 or 168. The animal feeder 160 then waits for the next scheduled feeding event from the timer circuit.

In another example, the animal feeder 160 comprises a second array of upper and lower bins opposite the first, with the solenoid 174 and guide rod 172 in between. In this embodiment, the stop block is lengthened to allow for alignment with the second set of catches. The solenoid, in this embodiment, may be a bi-directional solenoid, having the ability to push in the direction of the first bin on one feeding and in the direction of the second bin on the next feeding. After the first bin door is released the stop block remains engaged with the opposing side's catch pin so the solenoid does not advance until after the second trap door is released. When the second trap door is released, the horizontal spring forces the solenoid to the next set of trap doors to wait for the next scheduled feeding.

In yet another example, the animal feeder 160 comprises a second array of bins opposite the first, with the solenoid 174 and guide rod 172 in between. In this embodiment, the catch pins on one side are lengthened and designed with a reverse-hook latch to allow them to rest on the bottom plate next to the catch pins from the first side. The solenoid, in this embodiment, is a one-directional solenoid that releases the first bin on one feeding. After the first bin door is released the stop block advances to the opposing side's catch pin and waits until the next scheduled feeding event. When the second trap door is released, the horizontal spring forces the solenoid to the next set of trap doors to wait for the next scheduled feeding.

In another example, the upper and lower bin array is applied to a radially-designed animal feeder of the present invention. By adding an upper row of bins, the feeding range of the animal feeder is effectively doubled between fillings. The longer time between fillings reduces the amount of human scent in the desired feeding location.

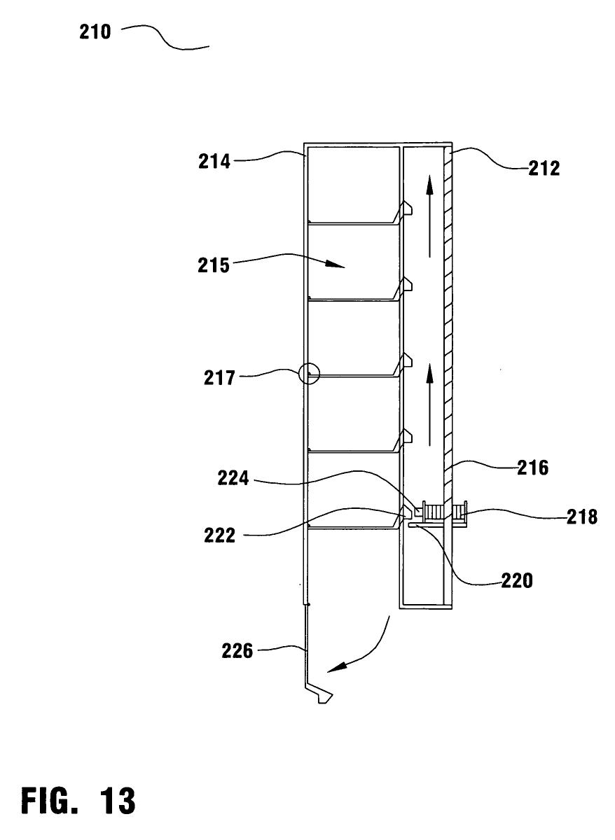

Referring now to FIG. 13, another example of an apparatus for dispensing bulky food items in accordance with one embodiment of the invention is illustrated. A vertical animal feeder 210 for bulk food items is shown in side-view. The animal feeder 210 comprises a plurality of bins 215 that are aligned in a vertical rectangular array. A separate trap door 226 is included for each bin. Each trap door 226 is connected to the bin frame 214 and a catch 222 by a spring hinge 217. Each catch 222 rests in a notch (not shown) in the bin frame 214 opposite the spring hinge 217 when in the loaded position. The bin frame 214 has a set of frame mounts (not shown) on the back of the animal feeder 210. The side cover for the animal feeder 210 in this embodiment is not shown. However, it is designed such that the electromechanical release mechanism and the bins are sealed to protect the feeder, and the enclosed bait from the elements and other non-desired wildlife intrusions. The bin frame 214 in this embodiment is shown with six bins. However, it is understood that any number of bins could be constructed within the scope of the present invention.

During the release process, an individual bin catch 222 is triggered, or pushed, off of the notch (not shown) in the bin frame 214 and the trap door 226 is opened to release the bulk food item. The trap door 226 remains open until the bin is re-loaded by the user. The solenoid 218 and stop block 220 slide over a guide rod 212. The guide rod 212, in turn, is attached to the vertical spring 216. Further, the solenoid 218 slides along the guide rod 212 such that the solenoid 218 is capable of traveling the extent of the guide rod 212. The vertical spring 216 is further attached to the bin frame 214 such that a vertical spring force can be applied to the solenoid 218. The stop block 220 is aligned to engage the bottom of each catch 222 such that the travel of the solenoid 218 is stopped by the catch 222. Finally, the solenoid push pin 224 is aligned to the same plane as the catch 222. When the solenoid 218 is energized, the push pin 224 will be electromechanically driven into the catch 222 with sufficient energy to force the catch 222 out of the notch (not shown) in the bin frame 214.

Prior to loading with bait, the operator lowers the solenoid 218 in order to tension the vertical spring 216. The bin 215 is loaded with the desired food items and the trap door 226 is closed. The trap door is supported by the spring hinge 217 and the catch 222, which rests in a notch (not shown) in the bin frame 214. The vertical spring 216 forces the stop block 220 to rest against the catch pin 222 until the solenoid 218 is triggered by the timer circuit (not shown) that is powered by the battery compartment (not shown). When the solenoid push pin 224 is engaged by the solenoid 218 it pushes to the left and into the catch pin 222. The force of the solenoid push pin 224 pushes the catch 222 to the left and out of the notch (not shown) in the bin frame 214 such that the trap door 226 opens and releases the food items from the bin 215.

After the solenoid 218 is triggered and the trap door 226 is opened, the vertical spring 216 pulls the advancement of the solenoid stop block 220 up to the location of the next available catch 222. Alternatively, a weight or a motor may be used to move the solenoid. The animal feeder 210 then waits for the next scheduled feeding event from the timer circuit.

In another example, the animal feeder 210 includes a second array of bins, not shown, opposite the first, with the solenoid 218 and guide rod 212 in between. In this embodiment, the stop block is lengthened to allow for alignment with the second set of catches. The solenoid, in this embodiment, is a bi-directional solenoid, having the ability to push in the direction of the first bin on one feeding and in the direction of the second bin on the next feeding. After the first bin door is released the stop block remains engaged with the opposing side's catch pin so the solenoid does not advance until after the second trap door is released. When the second trap door is released, the vertical spring pulls the solenoid up to the next set of trap doors to wait for the next scheduled feeding.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. An animal feeder apparatus for dispensing bulky food items, said apparatus including:
a plurality of walled bins each having a trap door and a catch wherein the catch, when engaged, is operative to support the trap door;
a solenoid operative, when energized, to release one of the trap doors by forcibly disengaging the catch supporting that trap door;
a means operative to move the solenoid between the walled bins; and
a means operative to briefly energize the solenoid at predetermined times.

2. The apparatus of claim 1 wherein the means operative to move the solenoid is a spring operatively coupled to the solenoid.

3. The apparatus of claim 1 wherein the means operative to move the solenoid is a weight operatively coupled to the solenoid.

4. The apparatus of claim 1 further including a means operative to stop the solenoid at each walled bin until the trap door for that bin is released.

5. The apparatus of claim 1 wherein the catch slides to disengage.

6. The apparatus of claim 1 wherein the catch flexes to disengage.

7. The apparatus of claim 1 wherein the catch pivots to disengage.

8. The apparatus of claim 1 wherein the means operative to briefly energize the solenoid at predetermined times includes a timer and a power supply operatively coupled to the solenoid.

9. The apparatus of claim 8 wherein the power supply is a battery.

10. The apparatus of claim 1 wherein the walled bins are arranged in a radial pattern.

11. The apparatus of claim 1 wherein the walled bins are arranged in a rectangular pattern.

12. An animal feeder apparatus for dispensing bulky food items, said apparatus including:
a plurality of walled bins each having a trap door and a catch wherein the catch, when engaged, is operative to support the trap door;
a solenoid operative, when energized, to release any trap door by forcibly disengaging the catch for that trap door;
a means operative to move the solenoid between the walled bins;
a means operative to stop the solenoid at each walled bin until the trap door for that bin is released; and
a timer and battery operatively coupled to the solenoid and operative to energize the solenoid at predetermined times.

13. The apparatus of claim 12 wherein the means operative to move the solenoid is a spring operatively coupled to the solenoid.

14. The apparatus of claim 12 wherein the means operative to move the solenoid is a weight operatively coupled to the solenoid.

15. A method of dispensing bulky food items including the steps of:
providing a plurality of walled bins, each walled bin having a trap door and a catch wherein the catch, when engaged, is operative to support the trap door;
closing the trap doors by engaging the catches;
thereafter loading bulky food items into the walled bins; and
dispensing the bulky food items from each walled bin, one walled bin at a time, including repeating the steps of:
waiting a predetermined time;
briefly energizing a solenoid to forcibly disengage the catch for that walled bin to thereby release the trap door and to dispense the bulky food items; and
moving the solenoid to another walled bin;

16. The method of claim 15 wherein the catch slides or flexes to disengage.

17. The method of claim 15 wherein the steps of waiting a predetermined time and of briefly energizing a solenoid to forcibly disengage the catch for that walled bin to thereby release the trap door and to dispense the bulky food items are performed by a timer and power supply operatively coupled to the solenoid.

18. The method of claim 15 wherein the step of moving the solenoid to another walled bin is performed by a spring or a weight operatively coupled to the solenoid and operative to move the solenoid between the wall bins.

19. The method of claim 15 wherein the solenoid is stopped at each walled bin until the trap door for that walled bin is released.

20. The method of claim 15 wherein the walled bins are arranged in a radial pattern or a rectangular pattern.
